(19) United States
(12) Patent Application Publication
(10) Pub. No.: US 2016/0122682 A1
(43) Pub. Date: May 5, 2016

(54) POLYMER SLIDING MATERIAL WITH DRY-RUN CAPABILITY AND SLIDE RING SEAL WITH DRY-RUN CAPABILITY

(71) Applicant: 3M INNOVATIVE PROPERTIES COMPANY, St. Paul, MN (US)

(72) Inventors: Armin Kayser, Groenenbach (DE); Ursula Kayser, Buchenberg (DE); Florian Grimm, Kempten (DE)

(21) Appl. No.: 14/778,668

(22) PCT Filed: Mar. 21, 2014
(86) PCT No.: PCT/EP2014/055707

§ 371 Date: Dec. 16, 2015

(30) Foreign Application Priority Data
Mar. 22, 2013 (EP) 13160642.8

(51) Int. Cl. C10M 169/04; C10M 107/38; F16J 15/34; C10M 125/02; C10M 125/26; C10M 107/32; C10M 107/46

(52) U.S. Cl. CPC C10M 169/04; C10M 107/32; C10M 107/38; C10M 107/46; C10M 125/02; C10M 125/26; F16J 15/3496

(57) ABSTRACT

The invention relates to a polymer sliding material, capable of running dry and comprising a polymer matrix material and fillers, wherein the fillers comprise reinforcing particles, hard material particles and lubricant particles.

The invention furthermore relates to a mechanical seal, comprising a rotating sealing ring and a stationary counter ring, wherein the sealing ring and/or the counter ring encompass the polymer sliding material, which is capable of running dry.

Furthermore, the invention relates to the use of such polymer materials, which are capable of running dry, for dry-running applications, especially as a material for displacement elements in wet-running and dry-running pumps.

### TECHNICAL FIELD

The present invention relates to a polymer sliding material, which is capable of running dry, to a mechanical seal and a sealing ring of a polymer sliding material, which is capable of running dry as well as to the use of such materials for dry-running applications, especially as displacement elements in wet-running and dry-running pumps.

### BACKGROUND OF THE INVENTION

Medium-lubricated mechanical seals are used, for example, as drive shaft seals in pump drives, where they seal liquid pressure from the surroundings and from the driving mechanism. Because of their simple construction and their performance, pumps with mechanical seals are widely used for conveying and circulating liquids.

For this type of pump, about 50% of the damage is caused by mechanical seals and more than half of these cases are attributed to the fact that the mechanical seals have run dry. Dry running may result from defective handling, especially if the supply of liquid is interrupted.

Special constructions of mechanical seals can also run dry permanently and, in so doing, seal the agitator shafts, for example, at the bushing to the pressure vessels. Until now, agitator seals have been made from the mechanical seal pairing of graphite and silicon carbide. However, the performance of these materials is limited. For many applications, especially the resulting graphite abrasion is not acceptable.

For mechanical seals, which run dry permanently or are lubricated by a medium, mechanical friction losses are dissipated as heat input into the liquid lubricating medium and into the bearing seats. In the absence of liquid lubrication under dry-running conditions, frictional losses, and thus the input of heat, are clearly increased. In addition, heat is not dissipated by the liquid. As a result, in conventional seal pairings such as SiC/SiC or Al₃/AlO₃, temperatures of more than 200° C. develop within a few minutes and directly cause thermal damage to the static secondary seals. The secondary seals usually are constructed as O-rings from elastomeric materials. This type of seal damage is responsible for about 50% of all pump damage in modern circulating pumps.

Displacement pumps, such as vacuum vane pumps, when used as brake boosters, are also not lubricated with a liquid in the operating state. In this procedure, the displacement elements (slide valves) which build up the pressure rub against the pump housing. This leads to high tribological heat in the frictional contact and to a high input of heat into the housing and the driving mechanism. With this type of pump as well, heat damage is the main cause of failure after long dry-running times.

In other displacement pumps, such as gear pumps, the displacement elements (gear wheels) are braced between pressure plates. The frictional contact between the pressure plates and the gear wheels, both of which usually are made from steel, leads to high frictional and performance losses. When running dry temporarily, a thermal overload may easily occur.

### PRIOR ART

In present-day types of pumps, with a medium-lubricated shaft-mechanical seals, usually a mechanical seal pairing, consisting of a rotating sealing ring of graphite and a stationary counter ring of sintered ceramic, is used. With these pairings, long service lives of up to 10 years of constant operation can be achieved at coefficients of friction of about 0.05 with liquid lubrication and of about 0.15 with brief dry-running times.

Polytetrafluoroethylene (PTFE) can also be used as an alternative to graphite as the material for the rotating sealing ring. However, because of its very low pressure and very low wear resistance, the pairing of PTFE with ceramic is suitable only for seals, which must withstand only a very small load, and it has not been used widely.

For medium-lubricated shaft mechanical seals which can withstand a significantly higher load, mechanical seal pairings, from the combination of ceramic against ceramic and preferably from sintered silicon carbide (SSiC) against SSiC, are used. With these pairings, coefficients of friction of about 0.05 can be attained with liquid lubrication; however, the dry-running coefficients of friction of about 0.8 are very high. These sealing ring pairings can therefore be used in dry-running operations for only a few minutes. By using variations of the silicon carbide material, for example, silicon carbide with graphite additives, slightly longer dry-running times of about 10 minutes are possible. However, these materials can also not be used for permanent dry-running operations.

At the present time, the material pairing of graphite and ceramic is therefore used for liquid-lubricated mechanical seals for uses, in which the sealing must be suitable for temporary dry-running operations.

Until now, no suitable pairs of materials have been available to the designer for permanent dry-running of mechanical seals. Because only brief dry-running times are possible, the pairing of graphite and ceramic as a mechanical seal cannot be used for a permanent dry-running application. In addition, this pairing is also disadvantageous because of strong noise development and because abraded graphite is discharged from the mechanical seal. Especially for agitator seals, which must be capable of running dry permanently, both effects are undesirable during use.

A structural solution for a mechanical seal, which is capable of running dry permanently, is the construction of the mechanical seal as a so-called gas seal, in which ceramic is paired with ceramic, the dry friction being lowered greatly by building up a gas film between the friction partners. However, very high RPMs, generally of above 10,000, are required for this purpose. Moreover, this solution is structurally very expensive and, until now, has been used only for larger installations such as gas compressors for overland pipelines.

Until now, polymer-based materials have not yet found wide use in media-lubricated mechanical seals or displacement pumps, although, especially for reasons of simplifying the process and the system and of lowering the costs associated therewith, the proportion of polymer materials in pump components has increased with each new generation of pumps. The material-related disadvantages of polymer-based materials are the poor dissipation of heat because of low thermal conductivity of less than 1.0 W/m*K, low dimensional stability under pressure and wear resistance, which has not been adequate until now. The high output of frictional heat which results during the operation of mechanical seals is dissipated very poorly by polymer materials. Moreover, the polymer materials already fail at comparatively low temperatures. Circulation pumps frequently are operated in pressurized water systems at about 140° C. Under these conditions, many conventional polymers fail due to hydrolysis and/or loss of mechanical strength.

WO 2012/169604 A1 describes a sealing ring which is produced from a resin composition containing polyphthalamide. In addition, the resin composition may contain fillers, such as carbon fibers, glass fibers, silicon carbide fibers, graphite, MoS₂, Al₂O₃, MgO, boron nitride and PTFE powder. However, the ceramic fillers, in the form of particles of fibers, lead to high wear at the tribological partners, and the resin compositions are not capable of running dry. The matrix material cannot be processed thermoplastically.

WO 2010/054241 A2 describes a method for producing a thermoplastic sealing ring, especially for seals of a very large diameter. For this purpose, an extruded strand is shaped into a ring and joined to the front face. The thermoplastic polymers may contain PTFE or carbon black as fillers.

In displacement pumps, such as vane pumps, sintered graphites have established themselves as the standard material for the slide elements for wet-running and for dry-running briefly. Some patent applications have also already proposed the use of polymer-based materials. However, the use of polymer-based materials, due to their so far unsatisfactory dry-running capability, has been limited to liquid-lubricated pumps.

DE 10 2008 019 440 A1 proposes the use of polymer materials for slide valves in dry-running vacuum pumps. The polymer materials used have no advantage over graphite in dry-running operations and have only limited wear resistance.

DE 20 2009 000 690 U1 describes a rotary displacement pump with bearings and displacement elements made from polymer materials such as Teflon or PEEK.

DE 20 2007 012 565 U1 describes a displacement pump with a rotor of a PEEK material.

The EP 1 424 495 A2 describes a positive displacement pump with a pump rotor and/or a rotor blade of polymer materials such as PEEK, PPS and PES. The materials listed have only limited dry-running capabilities, that is, they can run dry for only a short time and also only under moderate loads.

### OBJECT OF THE INVENTION

The invention therefore addresses the object of avoiding the disadvantages of the prior art and making a polymer sliding material available, as well as a mechanical seal made therefrom, which exhibits low losses due to friction and is wear resistant even over long running times under wet-running conditions and which is also capable of running dry permanently. Furthermore, the invention addresses the object of making available a polymer-based sliding material for displacement elements in dry-running pumps, the material making it possible to extend the dry-running time.

### SUMMARY OF THE INVENTION

The above-named object is achieved by the polymer sliding material of claim 1, the mechanical seal of claim 19 and the use of the polymer sliding material of claim 24. Preferred or especially appropriate embodiments of the polymer sliding material and of the mechanical seal are given in the dependent claims 2-18 and 20-23.

The subject matter of the invention accordingly is a polymer sliding material, comprising a polymer matrix material and fillers, the fillers comprising reinforcing particles, hard material particles and lubricants.

A further subject matter of the invention is a mechanical seal, comprising a rotating sealing ring and a stationary counter ring, the rotating sealing ring and/or the counter ring surrounding an polymer sliding material according to the invention.

A further subject matter of the invention is the use of such materials for dry-running applications, especially as a material for displacement elements in pumps running wet and dry.

The polymer sliding material according to the invention is wear resistant and mechanically stable and, unlike graphite, is capable of running dry permanently. The wear resistance is better than that of graphite.

The polymer sliding material according to the invention makes very low losses due to friction possible in wet-running and dry-running. It is suitable for permanent dry-running operations as a rotating sealing ring and/or as a stationary counter ring in mechanical seals and as displacement elements and wet-running and dry-running pumps, for example, as slide valves in vane pumps.

The mechanical seal according to the invention produces very low frictional losses and is distinguished by being able to run dry permanently.

The mechanical seal according to the invention can be produced cost-effectively and is distinguished by operating with little noise when running dry.

The operation of dry-running pumps with little noise is made possible by the use of the polymer sliding material according to the invention as displacement elements.

Preferably, the polymer sliding material according to the invention has a low specific density of 1.4-1.6 g/cm³. This is a further advantage over graphite (density 2.2 g/cm³) and, in rotary displacement pumps, additionally lowers the performance losses due to the reduced normal force acting on the friction partner.

The polymer sliding material according to the invention can be produced by injection molding, which makes the production of components with many design possibilities simple and cost-effective.

Sintered graphite materials which have previously been used as standard materials in pump applications can therefore be replaced by the polymer sliding materials according to the invention. As a result, polymer materials can be used for the first time in mechanical seals in pumps, which are operating under a slight to a moderate load of up to about 16 bar.

The dry-running coefficients of friction of the mechanical seal according to the invention are lower than those of comparable mechanical seals with polymer materials which were produced with the addition of reinforcing fibers and dry lubricants but without using hard material particles, especially submicron ceramic particles.

This improvement in properties was not expected since ceramic materials generally have very high dry coefficients of friction and are not capable of running dry. The dry coefficients of frictions of ceramic/steel and ceramic/ceramic pairings are >0.5. On the other hand, sintered graphites, when paired with steel and ceramic, have dry coefficients of frictions of 0.15-0.2. The dry coefficients of friction, achievable with the mechanical seals according to the invention, are below 0.1 and thus below the values achievable with the standard pairings of graphite and ceramic or graphite and steel. This improvement in properties is also surprising for a person skilled in the art.

A further advantage of the mechanical seal according to the invention is that the temperature increases only slightly in dry-running operations, which is necessary especially for protecting secondary polymer seals, such as O-rings.

When running dry, even at very high loads, such as rotational speeds of 3000 RPM and surface pressures of 0.6 MPa, the investigated rotating sealing rings of the polymer sliding material according to the invention exhibit a very flat surface which is almost free of traces of wear. Even after a longer period of use of one hour, the sliding surface is flat and shows only the slightest effects of positive mechanical engagement. Therefore, a very low coefficient of friction is maintained even under continuous operating conditions without liquid lubrication.

Under wet-running conditions, the coefficients of friction of the mechanical seal according to the invention with the polymer material according to the invention as the rotating sealing ring and Al₂O₃ ceramic as the counter ring of 0.015 are in the middle of the values measured and, accordingly, are less by a factor of 3 than the coefficients of frictions of conventional mechanical seals made from graphite and ceramic.

### DETAILED DESCRIPTION OF THE INVENTION

Materials, with a high chemical resistance in the media, used in household and motor vehicle circulating pumps, such as water, oil, brake fluid and glycol, are suitable as polymer matrix materials for the polymer sliding material according to the invention. Furthermore, the polymer matrix materials should be suitable for continuous operation at the maximum use temperatures. The maximum use temperatures are 140° C. for water and 220° C. for oil. The glass transition temperature of the polymer matrix material should be higher than these temperatures. For manufacturing reasons, the polymer matrix material preferably should be thermoplastically processable. Furthermore, the polymer matrix materials should have a good pressure resistance and a high modulus of elasticity for absorbing the mechanical forces with little deformation.

These requirements are fulfilled particularly by the high-temperature plastics, which can be processed thermoplastically, are used preferably as polymer matrix materials and comprise materials of the following classes: polyether ether ketones (PEEK), polyaryl ether ketones (PAEK), polyphenylene sulfides (PPS), polyether sulfones (PES, PESU), polyaryl sulfones (PSU, PPSU), polyether imides (PEI), polyamides (PA) and liquid crystalline polymers (LCP). However, other polymer matrix materials may also be used, such as the following, which cannot be processed thermoplastically: polyimide (PI), polybenzimidazole (PBI) and polytetrafluoroethylene (PTFE). Combinations of these classes of material are also possible.

The polymer sliding material according to the invention contains fillers, which can also be referred to as tribo additives. Reinforcing particles, lubricants and hard material particles are used as fillers.

The function of the reinforcing particles is to reinforce the polymer material mechanically. In particular, fibrous particles such as carbon and/or aramide fibers, are suitable as reinforcing particles. The addition of reinforcing particles increases the modulus of elasticity of the polymer materials. As the modulus of elasticity increases, the elastic deformation at a given pressure decreases, whereby the pressure absorbing capability of the pump components produced therefrom, such as the rotating sealing ring, and the load carrying capability of the mechanical seal increase. Because they support the sliding properties and reduce the abrasiveness at the counter ring of the mechanical seal, the use of carbon fibers as mechanical reinforcing particles for the polymer sliding material according to the invention is particularly preferred.

The content and the particle size or fiber length of the reinforcing particles is selected in such a way that the stiffness and strength values, which are optimal for the respective design, result. Preferably, the content of reinforcing particles is 1-20% by weight and particularly 5-20% by weight, based on the polymer sliding material.

Preferably, the length of the fibers, preferably used as reinforcing particles, such as carbon fibers, is less than 200 μm, since longer fibers are not stable during compounding and injection molding.

As hard material particles for the polymer sliding material according to the invention, silicon carbide, boron carbide, aluminum oxide, silicon dioxide, zirconium dioxide, silicon nitride and diamond particles may be used. Combinations of these hard material particles are also possible. Preferably, silicon carbide, boron carbide, aluminum oxide and silicon dioxide particles or combinations of these particles are used.

Preferably, silicon carbide particles are used as hard material particles. Silicon carbide fillers have a hardness of >9.5 Moh and are thus harder than all naturally occurring abrasive materials (with the exception of diamonds). In addition, in almost all liquid pump media, silicon carbide has very good corrosion resistance which exceeds by far that of known polymer matrix materials.

A further advantage of the version with silicon carbide fillers is the very high thermal conductivity of silicon carbide of more than 120 W/m·K, whereby the resulting frictional heat can be dissipated effectively even in the composite material.

Since coarse-grained ceramic fillers are highly abrasive when processed and in tribological contact with the counter ring, very fine grains with an average particle size (d₅₀) of not more than 1 μm are preferably used as hard material particles. It is particularly preferred if the average particle size (d₅₀) of the hard material particles is less than 1 μm (submicron particles) and even more preferred if it does not exceed 0.8 μm.

The hard material particles preferably have a low aspect ratio (the ratio of length to diameter) of 2 or lower; this has an advantageous effect on reducing abrasion.

The content of hard materials can be selected over a wide range up to the limit of the theoretical packing density of the particles. Preferably, the content of hard material particles is 1-30% by weight; good mechanical properties of the polymer material are obtained with these contents. It is particularly preferred if 5-20% by weight hard material particles are added, in each case based on the polymer sliding material.

The total content of reinforcing particles and hard material particles is preferably 2-50% by weight and particularly 10-30% by weight, based on the polymer sliding material.

The mixing ratio of reinforcing particles to hard material particles is selected according to the hardness, stiffness and strength desired for the respective application.

As lubricants, graphite, polytetrafluoroethylene (PTFE), boron nitride and molybdenum disulfide (MoS₂), for example, are suitable. Silicone oils also come into consideration. Lubricants are preferably used in the form of lubricating particles.

The average particle size (d₅₀) of the lubricating particles is preferably 1-50 μm.

The use of combinations of graphite and PTFE particles as lubricating particles is particularly preferred.

The total content of lubricants is preferably 1-40% by weight and particularly 10-30% by weight, based on the polymer sliding material.

For processing reasons, the total content of reinforcing particles, hard material particles and lubricants should not exceed 70% by weight. The total content of reinforcing particles, hard material particles and lubricants is preferably between 3 and 70% by weight and particularly between 30 and 50% by weight, based on the polymer sliding material. The total content of polymer matrix material is preferably 30-97% by weight and particularly 50-70% by weight, based on the polymer sliding material.

In relation to the total amount of hard material particles and reinforcing particles, the hard material particles are preferably contained in an amount of 20-90% by weight and particularly of 40-80% by weight.

In relation to the total amount of hard material particles and lubricants, the hard material particles are preferably contained in an amount of 10-70% by weight and particularly of 25-60% by weight.

In relation to the total amount of reinforcing particles and lubricants, the reinforcing particles are preferably contained in an amount of 10-70% by weight and particularly of 25-45% by weight.

In a preferred embodiment, a combination of carbon fibers, SiC submicron particles and lubricant particles are used as fillers for the polymer sliding material according to the invention. Here also, it is advantageous to use the preferred combination of graphite and PTFE particles as lubricant particles.

The modulus of elasticity, i.e., the stiffness of the polymer sliding material according to the invention is at least 7 GPa.

The rotating sealing ring and/or the rotating counter ring of the mechanical seal according to the invention encompasses the polymer sliding material according to the invention. In a preferred embodiment, the rotating sealing ring and/or the stationary counter ring of the mechanical seal according to the invention is constructed from the polymer sliding material according to the invention.

The sliding partner of the rotating sealing ring or counter ring of the mechanical seal according to the invention, encompassing the polymer sliding material according to the invention, that is, the stationary counter ring or also the rotating sealing ring, may be constructed from conventional mechanical seal materials, such as ceramic, graphite, hard metal, metal or bronze.

In a further possible embodiment, both the rotating sealing ring and the stationary counter ring are made from a polymer material; preferably, both rings are made from the polymer sliding material according to the invention. By these means, the total costs of the mechanical seal can be reduced even further.

Preferably, the rotating sealing ring of the mechanical seal according to the invention is constructed from the polymer sliding material according to the invention.

In a preferred embodiment of the mechanical seal according to the invention, the rotating sealing ring is made from the polymer sliding material according to the invention, and the counter ring is made from steel. This embodiment is particularly suitable for oil and hydraulic applications.

In a further preferred embodiment of the mechanical seal according to the invention, the sealing ring is made from the polymer sliding material according to the invention and the counter ring from a tight and finely grained sintered ceramic, such as aluminum oxide. The construction from a sintered silicon carbide (SSiC) is particularly advantageous. A suitable silicon carbide material is attainable under the name of EKasic® F from ESK Ceramics GmbH & Co. KG and has a thermal conductivity of >120 W/m·K.

The sliding surface of the rotating sealing ring and/or of the stationary counter ring preferably should have a very high surface quality, i.e., low roughness values. It was possible to show that the coefficient of friction and wear could be significantly reduced by decreasing the roughness values of the sealing ring and/or of the counter ring. It is particularly preferred if both the sealing ring and the counter ring have a polished sliding surface.

The sliding surface of the counter ring should preferably be constructed with little deviation from flatness.

The polymer sliding material according to the invention may be used continuously under dry-running conditions.

Aside from its use in a mechanical seal, the polymer sliding material according to the invention can also be used as a displacement element in wet-running and dry-running pumps. Examples of displacement elements are slide valves in displacement pumps such as vacuum vane pumps and pressure plates in gear pumps. Furthermore, the polymer sliding material according to the invention may also be used as a component in radial and axial bearings.

Displacement elements of the the polymer sliding material according to the invention and mechanical seals according to the invention can be used in hot water circulating pumps, drinking water pumps, cold water circulating pumps for internal combustion engines and electric drives, compressor pumps for condensation cooling cycles, vacuum pumps for brake boosters, displacement pumps for brake fluids (ESP and ABS systems), cooling water circulating pumps for cooling control cabinets, hydraulic units and laser devices.

Aside from dry-running applications, the displacement elements of the polymer sliding material according to the invention can also be used for applications in corrosive media such as alkaline solutions and acids, solvents, oils, low-viscosity fats and brake fluids.

Furthermore, the mechanical seal according to the invention is also suitable for seals in electric motors, especially in small motors, as long as permanent lubrication with oils, fats or other lubricants is ensured.

The polymer sliding material according to the invention is preferably converted by a thermoplastic injection molding process into components such as sealing rings and counter rings of the mechanical seal according to the invention and into displacement elements. Components with demanding complexity and functional integration requirements can also be produced on an industrial scale by the thermoplastic injection molding process. Customary methods of the art, such as twin screw extrusion, are used for mixing and compounding the polymer sliding materials.

To improve the dispersing properties, the hard material particles, before they are mixed and compounded, may be agglomerated, for example, by spray-drying. The average size of the agglomerates is preferably 70-150 μm here. The agglomerates easily disintegrate during the compounding with twin screw extrusion under standard settings and permit an efficient extrusion process even at high contents of hard material particles of up to 30% by weight. Processing of not agglomerated hard material particles is not preferred for particle sizes in the submicron range.

Other known prior art methods for producing polymer matrix materials may also be used for preparing the polymer sliding material according to the invention.

### EXAMPLES AND COMPARATIVE EXAMPLES

### Example 1

A filled polymer material is prepared by means of thermoplastic twin screw extrusion. The composition for the compounding by means of twin screw extrusion comprises 60% by weight PEEK (Victrex® PEEK 150), 10% by weight graphite, 10% by weight PTFE, 10% by weight carbon fibers and 10% by weight silicon carbide powder.

The silicon carbide powder has a purity of >96% and an average particle size (d₅₀) of 150 nm. In order to improve the dispersing properties, the silicon carbide powder is agglomerated by spray-drying from an aqueous suspension. The average size of the spray-dried agglomerate is 100 μm.

The agglomerates easily disintegrate during the compounding with twin screw extrusion at standard settings and make an efficient extrusion process possible.

### Example 2

A filled polymer material is prepared by means of thermoplastic twin screw extrusion. The composition for the compounding in the twin screw extruder comprises 55% by weight PPS (Fortron 0203 from Ticona), 10% by weight graphite, 10% by weight PTFE, 10% by weight carbon fibers and 15% by weight silicon carbide powder. The agglomerated powder, used in Example 1, is employed as silicon carbide powder.

### Example 3

A filled polymer material is prepared by means of thermoplastic twin screw extrusion. The composition for the compounding in the twin screw extruder comprises 60% by weight PESU (Polyether sulfone; Ultrason E 1010, BASF), 10% by weight graphite, 10% by weight PTFE, 10% by weight carbon fibers and 10% by weight silicon carbide powder. The powder, used in Example 1, is employed as silicon carbide powder.

### Example 4

The dry-running test is carried out in a test rig of the ring-on-ring type. For this purpose, rings of the material of Example 1 are produced for the stator by processing extruded rods mechanically. The rings have an external diameter Dₐ of 30 mm, and internal diameter Dᵢ of 20 mm and a height h of 16 mm. The sliding surface of the rings is polished finely, and the rings are subsequently inserted in the stator sample holder of the dry-run test rig. A ring of 1.4713 stainless steel with a finely polished surface is inserted in the sample holder for the rotor. The sliding surface of the stator is pressed pneumatically with a contacting pressure of 0.2 NiPa against the sliding surface of the rotor. After the motor is started, the rotor rotates at 1000 RPM, which corresponds to an average sliding speed of 1.3 m/s. The stator is mounted so that it can rotate and is held by a wire which leads to a load cell, so that the transmitted frictional force can be measured. A thermocouple which measures the temperature, is also fastened to the stator. The coefficient of friction is calculated from the measurement signal of the load cell and, together with the temperature, is recorded as a function of time.

The coefficient of friction μ is calculated from:

μ=(F_{LMD}*r_{LMD})/(p_{Fläche}*A_{Reib}*r_{Reib})

in which

F_{LMD} [N] is the frictional force, measured by the load cell

r_{LMD} [mm] is the radius, at which the frictional force is measured

p_{Fläche} [N/mm² is the surface pressure of the rings

A_{Reib} [mm²] is the engaging surface area

r_{Reib} [mm] is the average radius of the friction surface.

The average coefficient of friction over the whole of the running time, determined from the measurements obtained, as well as the temperature measured at the stator after one hour of the experiment, serve as evaluating parameters for the ability to run dry.

Table 1 shows the obtained measurements.

The higher the coefficient of friction, the greater the frictional energy, in the form of heat, and the faster the rise in temperature. The temperature depends not only on the heat of friction which has been introduced, but also on the thermal properties of the friction partners (heat capacity, thermal conductivity, heat flow into the sample and, over the sample holder, into the whole of the measurement apparatus). If the coefficient of friction is low, the temperature increases only slowly and then levels off at a plateau value, which is indicated in Table 1 in the “Comments” column by the statement “Plateau value”. This behavior is observed for all of the examples according to the invention. At high coefficients of friction, the temperature increases continuously until, at a temperature of >150° C., the test rig switches off.

The suitability of the examples of Table 1 for dry-running is given in Table 2, separately for the emergency mode of operation and for continuous use.

Materials which cope with a brief failure of the lubricating medium without overheating are rated as capable of running dry without overheating. In this connection, a time of up to 30 minutes is considered as brief. Materials which lead to overheating or which fail after a few minutes are not capable of running dry in an emergency mode of operation.

Materials which can run for a longer time without a lubricating medium without overheating are classified as being capable of running dry for continuous use. A time of one hour or more is considered as a longer time. A further essential criterion for the capability to run dry permanently is the adjustment of a constant temperature level (plateau) below a temperature which is critical for the system components (for example, for the experiments conducted here, the maximum temperature of 150° C. permissible for the test rig). This is the case when the heat of friction, introduced into the system during the dry running, is so slight, that it can be absorbed by the system or dissipated once again without a further rise in temperature. By such means, it is ensured that the temperature remains low permanently.

### Example 5

Example 4 was repeated; however, the stator was produced from the material of Example 2.

The measurements obtained are given in Table 1 and the evaluation of the dry-running ability is given in Table 2.

### Examples 6-8

Example 4 was repeated; however, the contacting pressure and the sliding speed were varied as shown in Table 1.

The measurements obtained are given in Table 1 and the evaluation of the dry-running ability is given in Table 2.

Even after very high loads, such as rotational speeds of 1000 RPM and at surface pressure of 0.6 MPa, the friction specimens of the materials according to the invention, examined after the dry-running test of Examples 4-8 had been carried out, showed a very flat surface which was almost free of traces of wear.

### Reference Example 1

The dry-running test of Example 5 was repeated; however, the stator ring for the dry-running test was prepared from a material corresponding to Example 1, however, without the addition of submicron hard material particles of silicon carbide. As fillers for the PEEK material, 10% by weight graphite, 10% by weight PTFE and 10% by weight carbon fibers were used (70% by weight PEEK).

The measurements obtained are given in Table 1 and the evaluation of the dry-running ability is given in Table 2.

The experiment was terminated after 4.5 minutes since the temperature at the stator was already 70° C. and a further temperature increase as steep as this would have led to the melting of the stator.

### Reference Example 2

The dry-running test of Example 5 was repeated; however, the stator ring for the dry-running test was prepared from a material corresponding to Example 2, however, without the addition of submicron hard material particles of silicon carbide. As fillers for the PPS material, 10% by weight graphite, 10% by weight PTFE and 10% by weight carbon fibers were used (70% by weight PPS).

The measurements obtained are given in Table 1 and the evaluation of the dry-running ability is given in Table 2.

The experiment was terminated after 2.5 minutes since the temperature at the stator was already 70° C. and a further temperature increase as steep as this would have led to the melting of the stator.

### Comparative Example 1

The dry-running test of Example 5 was repeated; however, with the exception that the stator ring for the dry-running test was produced from carbon graphite (EK3205, SGL Carbon) which had been impregnated with antimony. The contacting pressure was 0.2 MPa and the sliding speed was 1.3 m/s (as in Example 5, see Table 1).

The measurements obtained are given in Table 1 and the evaluation of the dry-running ability is given in Table 2.

After an experimental period of 60 minutes, the temperature at the stator was 120° C. and still rising. Accordingly, the mechanical seal pairing is not capable of running dry under continuous use conditions.

The mechanical seal pairing tested can be used for the emergency mode of operation; however the removal by abrasion of this pairing is significantly higher than that of Examples 4 and 5 according to the invention (see Table 1, last column).

### Comparative Example 2

The dry-running test of Example 8 was repeated; however, with the exception that the stator ring for the dry-running test was produced from carbon graphite (EK3205, SGL Carbon) which had been impregnated with antimony. The contacting pressure was 0.6 MPa and the sliding velocity was 3.9 m/s (as in Example 9, see Table 1).

The measurements obtained are given in Table 1 and the evaluation of the dry-running ability is given in Table 2.

The experiment was terminated after 24 minutes, since the stator temperature was already 150° C. and the dry-running test rig was not designed for higher temperatures.

TABLE 1
Dry-Running Test of the Ring-on-Ring Type

| | | | Average | | | |
|---|---|---|---|---|---|---|
| | | Contacting | coefficient of | Temperature | | |
| | | pressure p | friction for the | (stator) | | Abrasion at |
| | | [MPa]/Sliding- | whole of the | after 60 min | | the stator |
| Example No. | Stator | speed [m/s] | running time | [° C.] | Comments | [μm/h] |
| Example 4 | Example 1 | 0.2/1.3 | 0.074 | 52 | Plateau value | 1.91 |
| Example 5 | Example 2 | 0.2/1.3 | 0.098 | 50 | Plateau value | 2.48 |
| Example 6 | Example 1 | 0.4/1.3 | 0.035 | 48 | Plateau value | n.d. |
| Example 7 | Example 1 | 0.6/1.3 | 0.038 | 60 | Plateau value | n.d. |
| Example 8 | Example 1 | 0.2/3.9 | 0.037 | 47 | Plateau value | n.d. |
| Reference | PEEK with C | 0.2/1.3 | 0.34 | >70 | max. running | 14.1 |
| Example 1 | fibers/graphite/ | | | | time 4.5 min, | |
| | PTFE | | | | since T > 70° C. | |
| | | | | | was reached | |
| Reference | PPS with C | 0.2/1.3 | 0.59 | >70 | max. running | n.d. |
| Example 2 | fibers/graphite/ | | | | time 2.5 min, | |
| | PTFE | | | | since T > 70° C. | |
| | | | | | was reached | |
| Comparative | Carbon graphite | 0.2/1.3 | 0.19 | 120 | T increases | 13.6 |
| Example 1 | | | | | even more | |
| Comparative | Carbon graphite | 0.2/3.9 | 0.13 | >150 | max. running | n.d. |
| Example 2 | | | | | time 24 min, | |
| | | | | | since T > | |
| | | | | | 150° C. was | |
| | | | | | reached | |

n.d. = Not determined
Dₐ = 30 mm,
Dᵢ = 20 mm
Dry running against steel rotor
Temperature measurement at the stator
v = 1.3 m/s (1000 RPM) or 3.9 m/s (3000 RPM)
p = 0.2 MPa or 0.4 MPa or 0.6 Mpa

TABLE 2

| | | Dry-Running | Dry-Running |
|---|---|---|---|
| | | Capability | Capability |
| Example No. | Stator | Emergency Mode | Continues Use |
| Example 4 | Example 1 | yes | yes |
| Example 5 | Example 2 | yes | yes |
| Example 6 | Example 1 | yes | yes |
| Example 7 | Example 1 | yes | yes |
| Example 8 | Example 1 | yes | yes |
| Reference | PEEK with C | no | no |
| Example 1 | fibers/graphite/ | | |
| | PTFE | | |
| Reference | PPS with C- | no | no |
| Example 2 | fibers/graphite/ | | |
| | PTFE | | |
| Comparative | Carbon graphite | yes | no |
| Example 1 | | | |
| Comparative | Carbon graphite | no | no |
| Example 2 | | | |

1. A polymer sliding material, comprising a polymer matrix material and fillers, wherein the fillers comprise reinforcing particles, hard material particles and lubricants.

2. The polymer sliding material of claim 1, wherein the polymer matrix material is selected from the group consisting of polyether ether ketones (PEEK), polyaryl ether ketones (PAEK), polyphenylene sulfides (PPS), polyether sulfones (PES, PESU), polyaryl sulfones (PSU, PPSU), polyether imides (PEI), polyamides (PA), liquid crystalline polymers (LCP) and combinations thereof.

3. The polymer sliding material of claim 1, wherein the reinforcing particles comprise fibrous particles.

4. The polymer sliding material of claim 3, wherein the fibrous particles comprise carbon fibers and/or aramide fibers.

5. The polymer sliding material of claim 1, wherein the content of reinforcing particles is 1-20% by weight.

6. The polymer sliding material of claim 1, wherein the hard material particles are selected from the group consisting of silicon carbide, boron carbide, aluminum oxide, silicon dioxide, zirconium oxide, silicon nitride and diamond particles and combinations thereof.

7. (canceled)

8. The polymer sliding material of claim 1, wherein the hard material particles comprise submicron particles.

9. The polymer sliding material of claim 1, wherein the content of hard material particles is 1-30% by weight.

10. The polymer sliding material of claim 1, wherein the total content of reinforcing particles and hard material particles is 2-50% by weight, based on the polymer sliding material.

11. The polymer sliding material of claim 1, wherein the lubricants are selected from the group consisting of graphite, polytetrafluoroethylene (PTFE), boron nitride and molybdenum disulfide (MoS₂) particles and combinations thereof.

12. (canceled)

13. The polymer sliding material of claim 1, wherein the total content of lubricants is 1-40% by weight, based on the polymer sliding material.

14. The polymer sliding material of claim 1, wherein the total content of reinforcing particles, hard material particles and lubricants is 3-70% by weight, based on the polymer sliding material.

15. The polymer sliding material of claim 1, wherein the proportion of hard material particles in the total amount of reinforcing particles and hard material particles is 20-90% by weight.

16. The polymer sliding material of claim 1, wherein the proportion of hard material particles in the total amount of hard material particles and lubricants is 10-70% by weight.

17. The polymer sliding material of claim 1, wherein the proportion of reinforcing particles in the total amount of reinforcing particles and lubricants is 10-70% by weight.

18. The polymer sliding material of claim 1, wherein the modulus of elasticity of the polymer sliding material is at least 7 GPa.

19. A mechanical seal, comprising a rotating sealing ring and a stationary counter ring, wherein the sealing ring and/or the counter ring encompass a polymer sliding material of at least claim 1.

20. The mechanical seal of claim 19, wherein the sealing ring is constructed from a polymer sliding material of claim 1, and the counter ring is constructed from steel.

21. The mechanical seal of claim 19, wherein the sealing ring is constructed from a polymer sliding material of claim 1, and the counter ring is constructed from a sintered ceramic.

22-23. (canceled)

24. A use of the polymer sliding material of claim 1 as a material for a displacement element in wet-running and dry-running pumps.
